(19) United States
(12) Patent Application Publication
(10) Pub. No.: US 2025/0326375 A1
(43) Pub. Date: Oct. 23, 2025

(54) WIPER CONTROL DEVICE

(71) Applicant: DENSO ELECTRONICS CORPORATION, Anjo-city (JP)

(72) Inventor: Taiki SOMA, Anjo-city (JP)

(21) Appl. No.: 19/177,710

(22) Filed: Apr. 14, 2025

(30) Foreign Application Priority Data
Apr. 22, 2024 (JP) 2024-069205

(51) Int. Cl. B60S 1/08

(52) U.S. Cl. CPC B60S 1/0807

(57) ABSTRACT

A wiper control device includes: a wiper element; and a drive unit configured to control on/off of the wiper element. The drive unit is configured to decelerate a wiper by switching the wiper element from on to off to stop power supply from the wiper element to a motor of the wiper when a wiper angle reaches a deceleration start angle. The drive unit is configured to resume the power supply from the wiper element to the motor by switching the wiper element from off to on after the wiper angle reaches the deceleration start angle.

### CROSS REFERENCE TO RELATED APPLICATION

This application is based on Japanese Patent Application No. 2024-069205 filed on Apr. 22, 2024, the disclosure of which is incorporated herein by reference.

### TECHNICAL FIELD

The present disclosure relates to a wiper control device.

### BACKGROUND ART

In a method for controlling a wiper device, an electric motor that is driven in forward and reverse directions causes a wiper arm to reciprocate wiping operation between an upper reversing position and a lower reversing position.

### SUMMARY

According to an aspect of the present disclosure, a wiper control device includes: a wiper element to rotate a wiper motor by current passing through the wiper motor to drive a wiper that reciprocates between a first position and a second position; a drive unit configured to control on/off of the wiper element; an acquisition unit configured to acquire a value related to a current flowing through the wiper motor; an estimation unit configured to estimate a wiper angle that is a rotation angle of the wiper based on a current ripple having a periodicity corresponding to drive of the wiper motor, of the current flowing through the wiper motor; and a calculation unit configured to calculate a deceleration start angle based on a ripple period that is a period of the current ripple, the deceleration start angle being the wiper angle at which deceleration of the wiper is started before a position of the wiper reaches the first position and the second position. The drive unit is configured to: decelerate the wiper by switching the wiper element from on to off to stop power supply from the wiper element to the wiper motor when the wiper angle reaches the deceleration start angle; and resume the power supply from the wiper element to the wiper motor by switching the wiper element from off to on when the position of the wiper is one of the first position, a position earlier than the first position, the second position, and a position earlier than the second position after the wiper angle reaches the deceleration start angle.

### BRIEF DESCRIPTION OF DRAWINGS

FIG. 1 is a configuration diagram of a wiper drive system including a wiper control device according to a first embodiment.

FIG. 2 is a diagram illustrating a wiper of the wiper drive system.

FIG. 3 is a diagram illustrating a relationship between an electric current flowing through a wiper motor of the wiper drive system and time.

FIG. 4 is a flowchart illustrating processes executed by a drive unit of the wiper control device.

FIG. 5 is a diagram showing a relationship between a wiper angle and on/off states of a Hi switch and a Lo switch, for explaining the processing by the drive unit.

FIG. 6 is a diagram showing a relationship between a wiper angle and on/off states of a Hi switch and a Lo switch, for explaining the processing by the drive unit.

FIG. 7 is a flowchart showing processes executed by an estimation unit of the wiper control device.

FIG. 8 is a diagram for explaining calculation of the number of pulses by the estimation unit.

FIG. 9 is a flowchart showing processes executed by a calculation unit of the wiper control device.

FIG. 10 is a diagram showing a relationship between a ripple period and a deceleration start angle, for explaining calculation of the deceleration start angle by the calculation unit.

FIG. 11 is a diagram showing a relationship between a ripple period and a deceleration control time, for explaining calculation of the deceleration control time by the calculation unit.

FIG. 12 is a diagram showing a relationship between a wiper angle and on/off states of a Hi switch and a Lo switch, for explaining the processing by a drive unit of a wiper control device according to a second embodiment.

FIG. 13 is a configuration diagram of a wiper drive system including a wiper control device according to another embodiment.

FIG. 14 is a diagram for explaining calculation of the number of pulses by an estimation unit of a wiper control device according to another embodiment.

FIG. 15 is a diagram showing a relationship between a ripple period and a deceleration control time, for explaining calculation of the deceleration control time by a calculation unit of a wiper control device according to another embodiment.

### DETAILED DESCRIPTION

In a method for controlling a wiper device, an electric motor that is driven in forward and reverse directions causes a wiper arm to reciprocate wiping operation between an upper reversing position and a lower reversing position. In this method, the wiper arm is controlled to decelerate from a braking start position calculated based on the speed and load of the wiper arm near at least one of the two reversing positions toward the other reversing position. The speed of the wiper arm is detected based on the period of a motor pulse outputted in accordance with the rotation of the electric motor. The motor pulse has six cycles per one rotation of the rotary shaft of the electric motor, which is output from a Hall IC for detecting the position of the electric motor. Furthermore, the electric motor is pulse-driven by a pulse width modulation method, and the load on the wiper arm is detected based on the ratio of the on-time to the off-time of the pulse. The braking start position of the wiper arm is determined by a map having the speed and load of the wiper arm as parameters.

The method for controlling a wiper device requires a Hall IC for detecting the position of an electric motor in order to detect the speed of the wiper arm. This requires wiring for the Hall IC for detecting the position of the electric motor, which complicates the configuration of the wiper device. In addition, when the wiper arm operates, if the wiper arm has a speed due to inertia at the upper or lower reversing position, an overrun may occur. There is also a need to suppress the overrun, such that the wiper arm does not pass through the upper or lower reversing position.

The present disclosure provides a wiper control device to suppress such an overrun by estimating a wiper rotation angle with a simple configuration.

According to an aspect of the present disclosure, a wiper control device includes: an element for rotating a wiper motor by a current passing through the wiper motor to drive a wiper reciprocating between a first position and a second position; a drive unit for controlling on/off of the element; an acquisition unit for acquiring a value related to a current flowing through the wiper motor; an estimation unit for estimating a wiper angle that is a rotation angle of the wiper based on a current ripple of the current having a periodicity corresponding to drive of the wiper motor; and a calculation unit that calculates a deceleration start angle, based on a ripple period that is a period of the current ripple, which is the wiper angle at which the wiper starts to decelerate before a position of the wiper becomes the first position and the second position. When the element is on, the drive unit decelerates the wiper by stopping the power supply from the element to the wiper motor, at a timing when the wiper angle becomes the deceleration start angle, by switching the element from on to off. The drive unit resumes the power supply from the element to the wiper motor by switching the element from off to on when the wiper angle becomes one of the first position, a position earlier than the first position, the second position, and a position earlier than the second position, after the wiper angle becomes the deceleration start angle.

This allows the wiper angle to be estimated without providing a Hall IC for detecting the position of the electric motor. This eliminates the need to provide wiring for a Hall IC for detecting the position of the electric motor. Therefore, the wiper angle can be estimated with a simple configuration. Moreover, the wiper is decelerated immediately before the first position or the second position, so that the wiper smoothly reverses the moving direction at the first position or the second position. This suppresses overrun of the wiper, such that the wiper can be restricted from passing the first or second position.

Embodiments will be described below with reference to the drawings. In the following embodiments, the same or equivalent parts are denoted by the same reference numerals, and their descriptions will be omitted.

### First Embodiment

A wiper control device of the present embodiment estimates a rotation angle of a wiper with a simple configuration and suppresses overrun of the wiper. The wiper control device can be adopted, for example, to a wiper drive system for a vehicle. First, a wiper drive system 1 will be described.

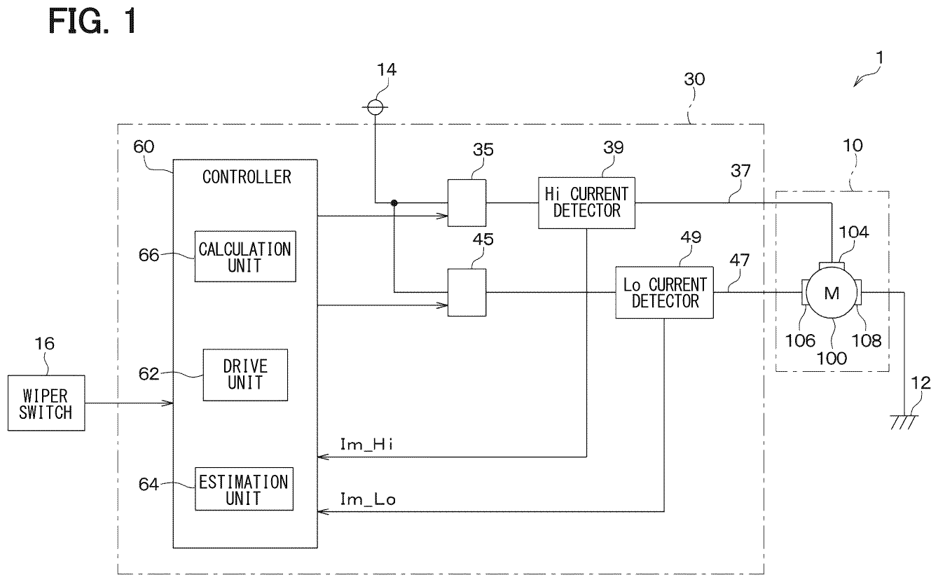

As illustrated in FIG. 1, the wiper drive system 1 includes a motor unit 10, a motor ground 12, a motor power supply 14, a wiper switch 16, and a wiper control device 30.

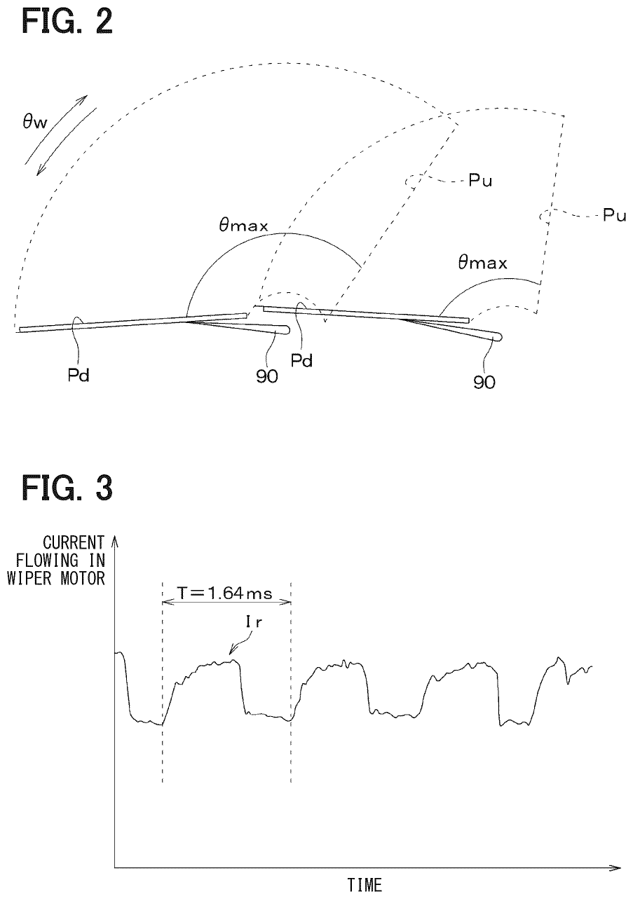

The motor unit 10 includes a wiper motor 100. The wiper motor 100 includes a Hi terminal 104, a Lo terminal 106, and a GND terminal 108. The Hi terminal 104 and the Lo terminal 106 are connected to the wiper control device 30. The GND terminal 108 is connected to the motor ground 12. The wiper motor 100 rotates at a relatively high speed by energization to the Hi terminal 104. When the Lo terminal 106 is energized, the wiper motor 100 rotates at a lower speed than when the Hi terminal 104 is energized. A wiper 90 of a vehicle as illustrated in FIG. 2 is operated by the rotation of the wiper motor 100 and a link mechanism (not shown) connected to the wiper motor 100.

The rotation of the wiper motor 100 causes the wiper 90 to reciprocate between a lower return position Pd and an upper return position Pu on a windshield (not shown). At this time, in the wiper motor 100, contact state and non-contact state are repeated between brush and commutator segments in a commutator of the wiper motor 100. As a result, the wiper motor 100 has characteristics in which, as illustrated in FIG. 3, a current ripple Ir that varies with periodicity according to the drive of the wiper motor 100 is generated in a current flowing through the wiper motor 100. The amplitude of the current ripple Ir is set to, for example, 1 to 2 A. Furthermore, the ripple period T, which is a period of the current ripple Ir, is set to, for example, about 1.64 ms. When the wiper switch 16 is turned off, the rotation of the wiper motor 100 is stopped so that the wiper 90 stops at the lower return position Pd.

As illustrated in FIG. 2, the rotation angle of the wiper 90 is defined as a wiper angle θw when reciprocating between the lower return position Pd and the upper return position Pu. An angle from the lower return position Pd to the upper return position Pu is defined as a maximum angle θ max. The maximum angle θ max is, for example, 100 degrees. A value of the wiper angle θw is within a range of zero to 2×θ max. The wiper position Pw is the lower return position Pd when the wiper angle θw is zero or 2×θ max. The wiper position Pw is the upper return position Pu when the wiper angle θw is θ max. The wiper 90 rotates from the lower return position Pd toward the upper return position Pu when 0<θw<θ max. When θ max<θw<2×θ max, the wiper 90 rotates from the upper return position Pu toward the lower return position Pd.

As shown in FIG. 1, the motor power supply 14 is a secondary battery such as a lithium ion battery, a nickel hydride battery, or a lead storage battery. A voltage of the motor power supply 14 is, for example, 12 V.

The wiper switch 16 is operated by an operator, and outputs a signal to a controller 60 of the wiper control device 30. The signal is for setting an operation state of the wiper 90 to one of a continuous high-speed mode, a continuous low-speed mode, an intermittent mode, and a stop.

The wiper control device 30 controls the wiper motor 100 by controlling a voltage applied to the wiper motor 100. Thus, the wiper control device 30 controls driving of the wiper 90 connected to the wiper motor 100. More specifically, the wiper control device 30 includes a Hi switch 35, a Hi wire 37, a Hi current detector 39, a Lo switch 45, a Lo wire 47, a Lo current detector 49, and the controller 60.

The Hi switch 35 includes a relay, a transistor, or the like. One end of the Hi switch 35 is connected to the motor power supply 14. The other end of the Hi switch 35 is connected to the Hi terminal 104 via the Hi wire 37. Moreover, the Hi switch 35 is turned on and off by a signal from the controller 60, which will be described later. As a result, the Hi terminal 104 is energized or interrupted.

The Hi current detector 39 includes a shunt resistor, a current mirror circuit, a Hall IC, or the like. The Hi current detector 39 detects a Hi current Im_Hi. Further, the Hi current detector 39 outputs a signal corresponding to the detected Hi current Im_Hi to the controller 60. The Hi current Im_Hi is an electric current flowing from the motor power supply 14 to the Hi terminal 104 via the Hi switch 35 and the Hi wire 37.

The Lo switch 45 includes a relay, a transistor, or the like. One end of the Lo switch 45 is connected to the motor power supply 14. The other end of the Lo switch 45 is connected to the Lo terminal 106 via the Lo wire 47. Moreover, the Lo switch 45 is turned on and off by a signal from the controller 60, which will be described later. As a result, the Lo terminal 106 is energized or interrupted.

The Lo current detector 49 includes a shunt resistor, a current mirror circuit, a Hall IC, or the like. The Lo current detector 49 detects the Lo current Im_Lo. Further, the Lo current detector 49 outputs a signal corresponding to the detected Lo current Im_Lo to the controller 60. The Lo current Im_Lo is an electric current flowing from the motor power supply 14 to the Lo terminal 106 via the Lo switch 45 and the Lo wire 47.

The controller 60 is mainly composed of a microcomputer and includes a CPU, ROM, flash memory, RAM, I/O, a drive circuit, an A/D converter, a comparator circuit, a DCDC converter, a low-pass filter, and bus lines connecting these components. The controller 60 is driven by a voltage from the motor power supply 14 or a power supply (not shown). Furthermore, the controller 60 has a drive unit 62, an estimation unit 64, and a calculation unit 66 as functional blocks.

The drive unit 62 executes program of the drive unit 62 to control the on/off of the Hi switch 35 and the Lo switch 45 based on signals from the wiper switch 16, the estimation unit 64, and the calculation unit 66. Thus, the drive unit 62 controls the voltage applied to the wiper motor 100. Therefore, the operation state of the wiper 90 becomes any one of the continuous high-speed mode, the continuous low-speed mode, the intermittent mode, and the stop. Moreover, when the wiper 90 moves to the lower return position Pd or the upper return position Pu, overrun of the wiper 90 is suppressed.

The estimation unit 64 executes program of the estimation unit 64 to estimate the wiper angle θw based on the signal from the wiper switch 16, the Hi current Im_Hi, and the Lo current Im_Lo. Furthermore, the estimation unit 64 outputs a signal corresponding to the estimated wiper angle θw to the drive unit 62.

The calculation unit 66 executes program of the calculation unit 66 to calculate the ripple period T based on the signal from the estimation unit 64. Furthermore, the calculation unit 66 calculates the deceleration start angle θb and the deceleration control time Tb based on the calculated ripple period T. Furthermore, the calculation unit 66 outputs a signal corresponding to the calculated deceleration start angle θb and deceleration control time Tb to the drive unit 62. The deceleration start angle θb is the wiper angle θw at which the drive unit 62 starts decelerating the wiper 90 before the wiper position Pw reaches the lower return position Pd and the upper return position Pu. During the deceleration control time Tb, the drive unit 62 performs deceleration control of the wiper 90 from when the wiper angle θw reaches the deceleration start angle θb.

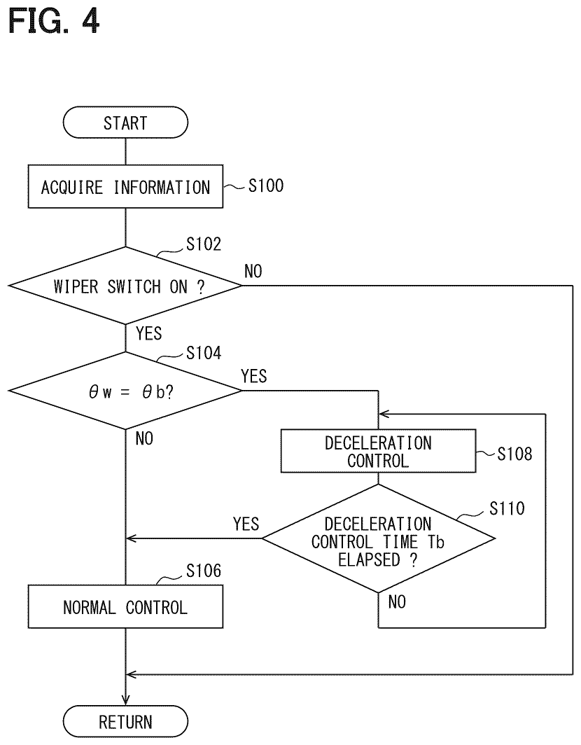

The wiper drive system 1 is configured as described above. Next, the control of the voltage applied to the wiper motor 100 by the execution of program by the drive unit 62 will be described with reference to the flowchart of FIG. 4. The program of the drive unit 62 is executed, for example, when the ignition or power supply of the vehicle (not shown) is turned on.

In step S100, the drive unit 62 acquires various types of information. More specifically, the drive unit 62 acquires a signal for setting the operation state of the wiper 90 to the continuous high-speed mode, the continuous low-speed mode, or the intermittent mode from the wiper switch 16. In addition, the drive unit 62 acquires the wiper angle θw from the estimation unit 64. Furthermore, the drive unit 62 acquires the deceleration start angle θb and the deceleration control time Tb from the calculation unit 66.

Subsequently, in step S102, the drive unit 62 determines whether the wiper switch 16 is ON based on the signal from the wiper switch 16 acquired in step S100. The drive unit 62 determines that the wiper switch 16 is turned on when the drive unit 62 acquires the signal for setting the operation state of the wiper 90 to the continuous high-speed mode, the continuous low-speed mode, or the intermittent mode in S100. Thereafter, the process of the drive unit 62 proceeds to S104. Further, the drive unit 62 determines that the wiper switch 16 is turned off when the drive unit 62 acquires the signal for stopping the operation state of the wiper 90 in step S100. At this time, since the wiper 90 stops and there is no need to drive the wiper 90, the process of the drive unit 62 returns to step S100.

In step S104 following step S102, the drive unit 62 determines whether the wiper angle θw acquired in step S100 is the deceleration start angle θb. This allows the drive unit 62 to determine whether or not it is time to decelerate the wiper 90.

When the wiper angle θw is not the deceleration start angle θb, it is not time to decelerate the wiper 90, so the process of the drive unit 62 proceeds to step S106, and normal control, which will be described later, is performed. Furthermore, when the wiper angle θw is the deceleration start angle θb, it is time to decelerate the wiper 90, so the process of the drive unit 62 proceeds to step S108, and deceleration control, which will be described later, is performed.

In step S106 following step S104, the drive unit 62 performs the normal control. Specifically, the drive unit 62 turns on the Hi switch 35 or the Lo switch 45. Accordingly, the wiper 90 is driven by the rotation of the wiper motor 100.

For example, it is assumed that the wiper switch 16 outputs the signal for setting the operation state of the wiper 90 to the continuous high-speed mode to the drive unit 62 by the operation of the operator. At this time, the drive unit 62 turns on the Hi switch 35. Accordingly, a voltage is applied from the motor power supply 14 to the wiper motor 100 via the Hi switch 35, the Hi wire 37, the Hi current detector 39 and the Hi terminal 104. As a result, the wiper motor 100 rotates at a higher speed than when the Lo terminal 106 is energized. Therefore, when the wiper 90 connected to the wiper motor 100 rotates at a high speed, the operation state of the wiper 90 becomes the continuous high-speed mode. At this time, the Lo switch 45 is off.

For example, it is assumed that the wiper switch 16 outputs the signal for setting the operation state of the wiper 90 to the continuous low-speed mode to the drive unit 62 by the operation of the operator. At this time, the drive unit 62 turns on the Lo switch 45. Accordingly, a voltage is applied from the motor power supply 14 to the wiper motor 100 via the Lo switch 45, the Lo wire 47, the Lo current detector 49 and the Lo terminal 106. As a result, the wiper motor 100 rotates at a lower speed than when the Hi terminal 104 is energized. Therefore, when the wiper 90 connected to the wiper motor 100 rotates at a low speed, the operation state of the wiper 90 becomes the continuous low-speed mode. At this time, the Hi switch 35 is off. When the wiper 90 is in the intermittent mode, the drive unit 62 turns on the Lo switch 45. As a result, the wiper motor 100 rotates at a low speed. When the wiper 90 reciprocates between the lower return position Pd and the upper return position Pu and the wiper position Pw is at the lower return position Pd, the drive unit 62 turns off the Lo switch 45. Therefore, the wiper motor 100 is temporarily stopped, so that the wiper 90 is temporarily stopped. Thereafter, the drive unit 62 turns on the Lo switch 45. As a result, the wiper motor 100 rotates at a low speed. Therefore, by these operations, the wiper 90 intermittently reciprocates between the lower return position Pd and the upper return position Pu.

After the drive unit 62 performs the normal control in this manner, the process of the drive unit 62 returns to step S100.

In step S108 following step S104, the wiper angle θw is the deceleration start angle θb. Therefore, in step S108, the drive unit 62 performs deceleration control.

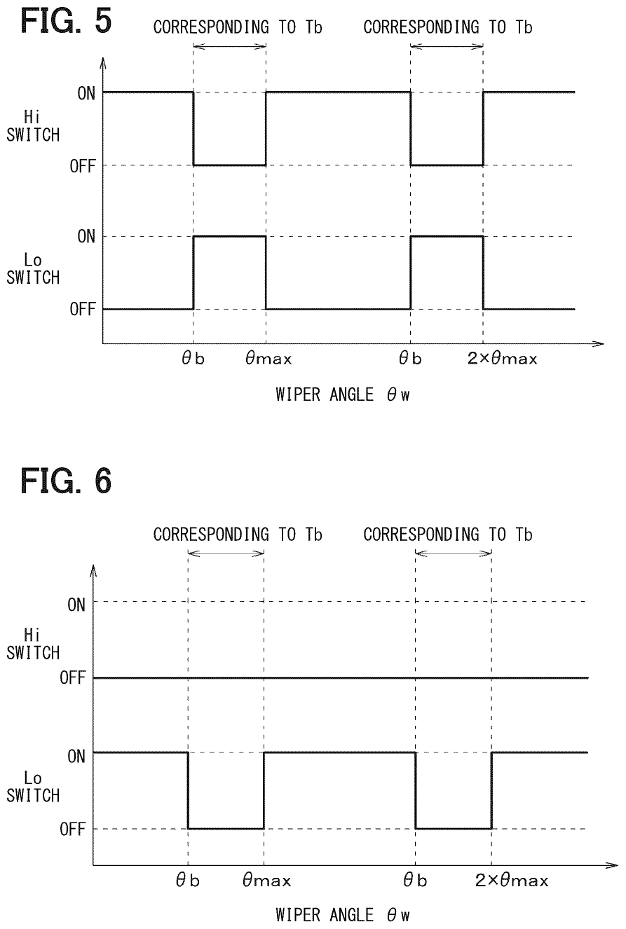

For example, it is assumed that the wiper switch 16 outputs the signal for setting the operation state of the wiper 90 to the continuous high-speed mode to the drive unit 62 by the operation of the operator. In this case, when the wiper angle θw is the deceleration start angle θb, as shown in FIG. 5, the drive unit 62 changes the Hi switch 35 from on to off. Accordingly, the drive unit 62 stops the power supply to the Hi terminal 104. At this time, the drive unit 62 also changes the Lo switch 45 from off to on. Accordingly, the drive unit 62 supplies power to the Lo terminal 106.

For example, it is assumed that the wiper switch 16 outputs the signal for setting the operation state of the wiper 90 to the continuous low-speed mode to the drive unit 62 by the operation of the operator. In this case, when the wiper angle θw is the deceleration start angle θb, as shown in FIG. 6, the drive unit 62 changes the Lo switch 45 from on to off. As a result, the drive unit 62 stops the power supply to the Lo terminal 106. The Hi switch 35 remains off.

By such a process of the drive unit 62, the wiper 90 is decelerated immediately before the lower return position Pd or the upper return position Pu, so that the wiper 90 smoothly reverses at the lower return position Pd or the upper return position Pu. As a result, overrun of the wiper 90 is restricted. Furthermore, the operating noise of the wiper 90 generated when the wiper position Pw is the lower return position Pd or the upper return position Pu is reduced. Thereafter, the process of the drive unit 62 proceeds to step S110.

Returning to the flowchart of FIG. 5, in step S110 following step S108, the drive unit 62 determines whether or not the deceleration control time Tb acquired in step S100 has elapsed since the wiper angle θw became the deceleration start angle θb. As a result, the drive unit 62 determines whether or not to return to the deceleration control in step S108 or the normal control in step S106.

When the deceleration control time Tb has not elapsed, the deceleration control in step S108 is continued. Furthermore, when the deceleration control time Tb has elapsed, if the operation state of the wiper 90 is the continuous high-speed mode, as shown in FIG. 5, the Hi switch 35 is returned from off to on, and the Lo switch 45 is returned from on to off. Furthermore, when the deceleration control time Tb has elapsed, if the operation state of the wiper 90 is the continuous low-speed mode, the Lo switch 45 is returned from off to on, as shown in FIG. 6. After the deceleration control time Tb has elapsed, the wiper position Pw is at the lower return position Pd or the upper return position Pu. Therefore, the process of the drive unit 62 proceeds to step S106. As a result, the control of the drive unit 62 returns from the deceleration control of step S108 to the normal control of step S106. Therefore, the power supply to the terminals corresponding to the switches that were turned off during the deceleration control time Tb is resumed.

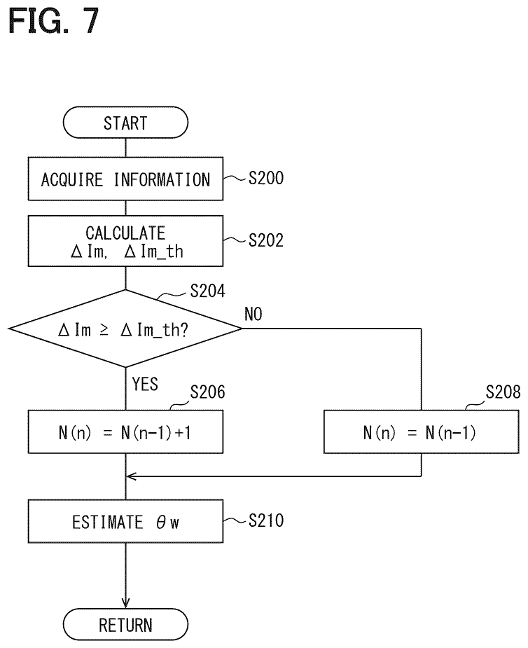

As described above, the drive unit 62 controls the voltage applied to the wiper motor 100. Next, the estimation of the wiper angle θw by the execution of program by the estimation unit 64 will be described with reference to the flowchart of FIG. 7. The program of the estimation unit 64 is executed, for example, when the ignition or power supply of the vehicle (not shown) is turned on. A period of a series of operations from the start of the process of S200 of the estimation unit 64 to the return to the process of S200 is defined as a control cycle τ of the estimation unit 64.

In S200, the estimation unit 64 acquires various types of information. More specifically, the estimation unit 64 acquires the signal for setting the operation state of the wiper 90 to one of the continuous high-speed mode, the continuous low-speed mode, the intermittent mode, and the stop from the wiper switch 16. In addition, the estimation unit 64 obtains the high current Im_Hi from the Hi current detector 39. Furthermore, the estimation unit 64 obtains the Lo current Im_Lo from the Lo current detector 49.

For example, it is assumed that the wiper 90 is in the continuous high-speed mode. At this time, the Hi switch 35 is turned on. Accordingly, a voltage is applied from the motor power supply 14 to the wiper motor 100 via the Hi switch 35, the Hi wire 37, the Hi current detector 39 and the Hi terminal 104. As a result, current flows through the wiper motor 100 to rotate the wiper motor 100, so that the high current Im_Hi includes the current ripple Ir. Therefore, the high current Im_Hi varies periodically.

For example, it is assumed that the operation state of the wiper 90 is the continuous low-speed mode or the intermittent mode. At this time, the Lo switch 45 is turned on. Accordingly, a voltage is applied from the motor power supply 14 to the wiper motor 100 via the Lo switch 45, the Lo wire 47, the Lo current detector 49 and the Lo terminal 106. As a result, current flows through the wiper motor 100 to rotate the wiper motor 100, so that the low current Im_Lo includes the current ripple Ir. Therefore, the low current Im_Lo varies periodically.

As described above, the current ripple Ir is generated due to the contact and non-contact between the commutator and the brush in the wiper motor 100. A change amount Δlm is defined while the wiper 90 moves from the lower return position Pd to the upper return position Pu and from the upper return position Pu to the lower return position Pd. The number of times that the change amount Δlm becomes equal to or greater than a change threshold value Δlm_th is uniquely determined by the structure of the wiper motor 100. Therefore, it is possible to estimate the wiper angle θw by counting the number of times that the change amount Δlm is equal to or greater than the change threshold value Δlm_th as the number of pulses N.

Since the current flowing through the wiper motor 100 changes in accordance with the change in voltage applied to the wiper motor 100, the current ripple Ir and the change amount Δlm change. Therefore, it is preferable to change the change threshold value Δlm_th according to the voltage applied to the wiper motor 100.

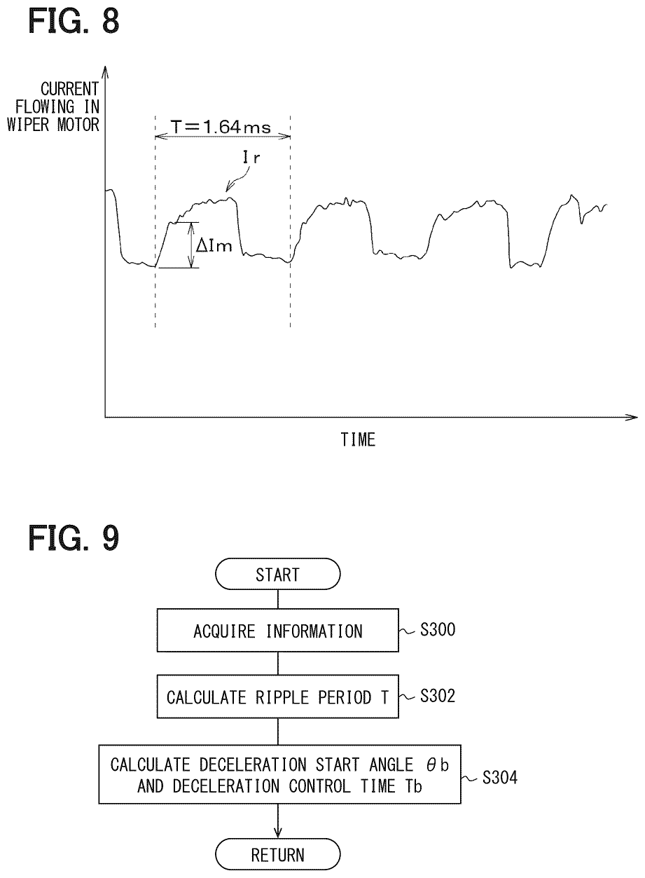

Therefore, in step S202 following step S200, the estimation unit 64 calculates the change amount Δlm as shown in FIG. 8. In addition, the estimation unit 64 calculates the change threshold value Δlm_th.

For example, it is assumed that the operation state of the wiper 90 is the continuous high-speed mode. In this case, the estimation unit 64 calculates a difference between the high current Im_Hi(n) in the current control cycle τ(n) and the high current Im_Hi(n−1) in the last control cycle τ(n−1). In this way, the estimation unit 64 calculates the change amount Δlm. The change amount Δlm may be the absolute value of the difference.

For example, it is assumed that the operation state of the wiper 90 is the continuous low-speed mode or the intermittent mode. In this case, the estimation unit 64 calculates a difference between the low current Im_Lo(n) in the current control cycle τ(n) and the low current Im_Lo(n−1) in the last control cycle τ(n−1). In this way, the estimation unit 64 calculates the change amount Δlm.

Furthermore, the estimation unit 64 calculates the change threshold value Δlm_th based on the voltage applied to the wiper motor 100. For example, the estimation unit 64 increases the change threshold value Δlm_th as the voltage applied to the wiper motor 100 increases.

Returning to the flowchart of FIG. 7, in step S204, the estimation unit 64 determines whether or not the change amount Δlm calculated in step S202 is equal to or greater than the change threshold value Δlm_th. When the change amount Δlm is equal to or greater than the change threshold value Δlm_th, the process of the estimation unit 64 proceeds to S206. When the change amount Δlm is less than the change threshold value Δlm_th, the process of the estimation unit 64 proceeds to S208.

In S206 subsequent to S204, the change amount Δlm is equal to or greater than the change threshold value Δlm_th. Therefore, at this time, the estimation unit 64 calculates the number of pulses N(n) in the current control cycle τ(n) by adding 1 to the number of pulses N(n−1) in the last control cycle τ(n−1).

In S208 subsequent to S204, the change amount Δlm is less than the change threshold value Δlm_th. Therefore, at this time, the estimation unit 64 sets the number of pulses N(n) in the current control cycle τ(n) to the number of pulses N(n−1) in the last control cycle τ(n−1).

As described above, the rotation angle of the wiper motor 100 can be estimated from the number of pulses N, specifically, the number of times that the change amount Δlm is equal to or greater than the change threshold value Δlm_th. Thus, the wiper angle θw can be estimated.

Therefore, in step S210, the estimation unit 64 estimates the wiper angle θw based on the wiper angle θw at which the number of pulses N changes per one time and the number of pulses N(n) in the current control cycle τ(n) calculated as above. Alternatively, the estimation unit 64 estimates the wiper angle θw based on the calculated number of pulses N(n) in the current control cycle τ(n) and a map. Furthermore, the estimation unit 64 outputs a signal corresponding to the estimated wiper angle θw to the drive unit 62. Thereafter, the process of the estimation unit 64 returns to S200. The wiper angle θw at which the number of pulses N changes per one time is determined in advance, for example, by dividing 2×θ max by the total number of the pulses N that the wiper angle θw changes from 0 to 2×θ max. The map for estimating the wiper angle θw from the number of pulses N is set based on the characteristics of the link mechanism (not shown) and the wiper motor 100, experiments, simulations, and the like. For example, it is assumed that the number of pulses N that the wiper 90 reciprocates between the lower return position Pd and the upper return position Pu is 1000 times. In this case, for example, when the number of pulses N(n) in the current control cycle τ(n) is 500, the wiper angle θw is estimated to be the maximum angle θ max, and the wiper position Pw is estimated to be the upper return position Pu. In this case, for example, when the number of pulses N(n) in the current control cycle τ(n) is 1000, the wiper angle θw is estimated to be 2×θ max, and the wiper position Pw is estimated to be the lower return position Pd. At this time, the number of pulses N may be reset.

In this manner, the estimation unit 64 estimates the wiper angle θw. Next, calculation of the ripple period T, the deceleration start angle θb, and the deceleration control time Tb by the execution of program by the calculation unit 66 will be described with reference to the flowchart of FIG. 9. The program of the calculation unit 66 is executed, for example, when the wiper switch 16 is turned on. Alternatively, the program of the calculation unit 66 is executed, for example, when the wiper angle θw reaches a specific angle before the deceleration start angle θb.

Here, the time required for the number of pulses N(n−1) in the previous control cycle τ(n−1) to reach the number of pulses N(n) in the current control cycle τ(n) corresponds to the ripple cycle T.

Therefore, in step S300, the calculation unit 66 obtains from the estimation unit 64 the times related to the number of pulses N(n) in the current control cycle τ(n) and the number of pulses N(n−1) in the previous control cycle τ(n−1) as information for calculating the ripple cycle T.

Next, in step S302, the calculation unit 66 calculates the ripple period T from the time acquired in step S300.

Subsequently, in step S304, the calculation unit 66 calculates the deceleration start angle θb and the deceleration control time Tb based on the ripple period T calculated in step S302 and the map.

When the ripple period T is short, the wiper 90 and the wiper motor 100 rotate at high speed. Therefore, at this time, in order to restrict the wiper 90 from overrunning, it is required to decelerate the wiper 90 early. Furthermore, when the ripple period T is long, the wiper 90 and the wiper motor 100 rotate at a low speed. Therefore, at this time, it is not necessary to decelerate the wiper 90 early.

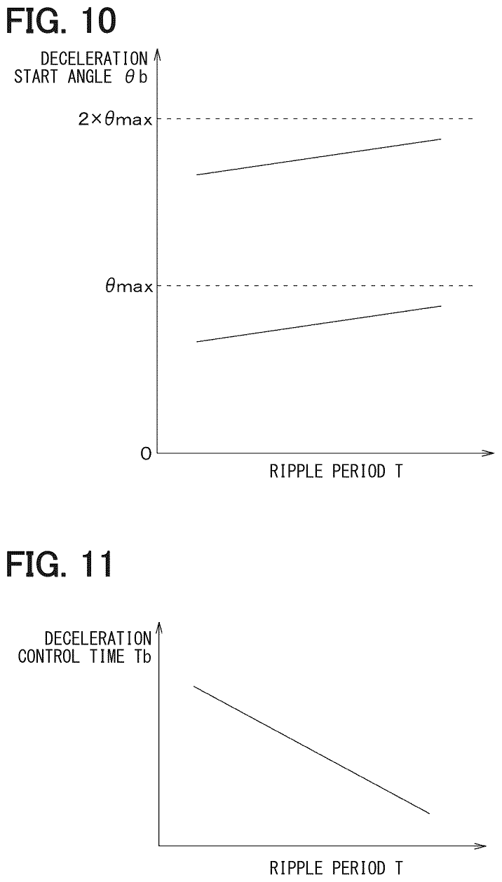

Therefore, the map for calculating the deceleration start angle θb is set, as shown in FIG. 10, so that the deceleration start angle θb becomes smaller as the ripple period T becomes shorter in both the range from 0 to θ max and the range from θ max to 2×θ max.

When the wiper 90 and the wiper motor 100 are rotating at high speed, the longer the deceleration control time Tb, the easier it is to decelerate the wiper 90 and the wiper motor 100. Furthermore, when the wiper 90 and the wiper motor 100 are rotating at a low speed, the deceleration control time Tb may be short.

Therefore, the map for calculating the deceleration control time Tb is set so that the deceleration control time Tb becomes longer as the ripple period T becomes shorter, for example, as shown in FIG. 11.

Then, the calculation unit 66 outputs a signal according to the calculated deceleration start angle θb and deceleration control time Tb to the drive unit 62. Thereafter, the process of the calculation unit 66 returns to step S300. At this time, if the program of the calculation unit 66 is executed because the wiper angle θw has reached a specific angle before the deceleration start angle θb, the processing of the calculation unit 66 may be terminated.

As described above, the calculation unit 66 estimates the ripple period T, the deceleration start angle θb, and the deceleration control time Tb. Next, a description will be given of how the wiper angle θw is estimated with a simple configuration in the wiper control device 30 and how overrun of the wiper 90 is suppressed.

In a comparison example, a Hall IC for detecting the position of the electric motor is required to detect the speed of the wiper arm, in the control method of the wiper device. This requires wiring for the Hall IC for detecting the position of the electric motor, which complicates the configuration of the wiper device of the comparison example. In addition, when the wiper arm operates, if the wiper arm has a speed due to inertia at the upper or lower return position, an overrun may occur, in which the wiper arm passes through the targeted return position. When an overrun occurs, for example, a wiper blade connected to the wiper arm may come into contact with an A-pillar of the vehicle body. For example, if the wiper blades are mechanically reversed just before the return position in anticipation of an overrun, water and other particles on the windshield of the vehicle may not be wiped clean, which may obstruct the driver's visibility. For this reason, there is a need to suppress this overrun.

In contrast, the wiper control device 30 of the present embodiment includes the Hi switch 35, the Lo switch 45, the drive unit 62, the estimation unit 64, and the calculation unit 66. The Hi switch 35 and the Lo switch 45 correspond to a wiper element to rotate the wiper motor 100. The wiper motor 100 drives the wiper 90. The wiper 90 reciprocates between the lower return position Pd and the upper return position Pu. The lower return position Pd corresponds to a first position. The upper return position Pu corresponds to a second position.

The drive unit 62 controls the on/off of the Hi switch 35 and the Lo switch 45. The estimation unit 64 serves as an acquisition unit that acquires a value related to the current flowing through the wiper motor 100 in S200. In S210, the estimation unit 64 estimates the wiper angle θw based on the current ripple Ir, which is included in the current flowing through the wiper motor 100 and has a periodicity corresponding to the driving of the wiper motor 100. The calculation unit 66 calculates the deceleration start angle θb based on the ripple period T in step S304.

Furthermore, when the Hi switch 35 or the Lo switch 45 is on, the drive unit 62 turns off the Hi switch 35 or the Lo switch 45, which was on, when the wiper angle θw becomes the deceleration start angle θb. As a result, the drive unit 62 stops the power supply from the Hi switch 35 or the Lo switch 45 to the wiper motor 100, thereby decelerating the wiper 90.

After the wiper angle θw reaches the deceleration start angle θb, the wiper position Pw is located at the lower return position Pd, a position earlier than the lower return position Pd, the upper return position Pu, or a position earlier than the upper return position Pu. At this time, the drive unit 62 turns on the Hi switch 35 or the Lo switch 45 that was turned off. As a result, the drive unit 62 resumes the power supply from the Hi switch 35 or the Lo switch 45 to the wiper motor 100.

In this way, the wiper angle θw can be estimated without providing a Hall IC for detecting the position of the electric motor. This eliminates the need to provide wiring for a Hall IC for detecting the position of the electric motor. Therefore, the wiper angle θw can be estimated with a simple configuration. Here, a cam switch that is turned on and off in response to the rotation of the wiper motor 100 may be used to determine whether the wiper position Pw is at or near the lower return position Pd. In contrast, since the wiper control device 30 of the present embodiment estimates the wiper position Pw by the above configuration, the cam switch does not have to be provided.

Moreover, the wiper 90 is decelerated immediately before the lower return position Pd or the upper return position Pu, so that the wiper 90 smoothly reverses at the lower return position Pd or the upper return position Pu. As a result, overrun of the wiper 90 is restricted. Furthermore, the operating noise of the wiper 90 generated when the wiper position Pw is the lower return position Pd or the upper return position Pu is reduced.

The first embodiment also achieves the following effects.

After the deceleration control time Tb has elapsed since the wiper angle θw becomes the deceleration start angle θb, the drive unit 62 turns on the Hi switch 35 or the Lo switch 45 that was turned off. As a result, the drive unit 62 resumes the power supply from the Hi switch 35 or the Lo switch 45 to the wiper motor 100.

Since the deceleration of the wiper 90 is adjusted, the wiper 90 can move smoothly to the lower return position Pd or the upper return position Pu. As a result, overrun of the wiper 90 is restricted.

The wiper motor 100 has the Hi terminal 104 and the Lo terminal 106. When the Hi switch 35 is turned on, current flows through the wiper motor 100 via the Hi terminal 104, thereby rotating the wiper motor 100. When the Lo switch 45 is turned on, current flows to the wiper motor 100 via the Lo terminal 106, thereby rotating the wiper motor 100.

When the Hi switch 35 is on and the Lo switch 45 is off, that is, when the operation state of the wiper 90 is the continuous high-speed mode, it is assumed that the wiper angle θw becomes the deceleration start angle θb. At this time, in the first embodiment, the drive unit 62 stops the power supply from the Hi switch 35 to the wiper motor 100 by switching the Hi switch 35 from on to off. Furthermore, the drive unit 62 switches the Lo switch 45 from off to on to supply power from the Lo switch 45 to the wiper motor 100, thereby decelerating the wiper 90.

Furthermore, after the wiper angle θw reaches the deceleration start angle θb, the wiper position Pw is at the lower return position Pd, a position earlier than the lower return position Pd, the upper return position Pu, or a position earlier than the upper return position Pu. At this time, the drive unit 62 switches the Hi switch 35 from off to on, thereby restarting the power supply from the Hi switch 35 to the wiper motor 100. In addition, the drive unit 62 stops the power supply from the Lo switch 45 to the wiper motor 100 by switching the Lo switch 45 from on to off. In this case, the Hi terminal 104 corresponds to a first terminal. The Lo terminal 106 corresponds to a second terminal. The Hi switch 35 corresponds to a first element. The Lo switch 45 corresponds to a second element.

When the Hi switch 35 is off and the Lo switch 45 is on, that is, when the operation state of the wiper 90 is the continuous low-speed mode, it is assumed that the wiper angle θw becomes the deceleration start angle θb. At this time, the drive unit 62 stops the power supply from the Hi switch 35 to the wiper motor 100 by turning the Lo switch 45 from on to off, and decelerates the wiper 90 by keeping the Hi switch 35 off.

Furthermore, after the wiper angle θw reaches the deceleration start angle θb, the wiper position Pw is at the lower return position Pd, a position earlier than the lower return position Pd, the upper return position Pu, or a position earlier than the upper return position Pu. At this time, the drive unit 62 switches the Lo switch 45 from off to on to resume the power supply from the Lo switch 45 to the wiper motor 100 and keeps the Hi switch 35 off. In this case, the Hi switch 35 corresponds to a first element, and the Lo switch 45 corresponds to a second element. Alternatively, the Lo switch 45 corresponds to a first element, and the Hi switch 35 corresponds to a second element.

By these processes, as described above, the wiper 90 is decelerated immediately before the lower return position Pd or the upper return position Pu, so that the wiper 90 smoothly reverses at the lower return position Pd or the upper return position Pu. As a result, overrun of the wiper 90 is restricted. Furthermore, the operating noise of the wiper 90 generated when the wiper position Pw is the lower return position Pd or the upper return position Pu is reduced.

### Second Embodiment

In the second embodiment, the deceleration control by the drive unit 62 is different from that in the first embodiment. The other configurations are the same as those of the first embodiment.

In the first embodiment, in step S108, in case where the operating state of the wiper 90 is the continuous high-speed mode, when the wiper angle θw is the deceleration start angle θb, the drive unit 62 changes the Lo switch 45 from off to on.

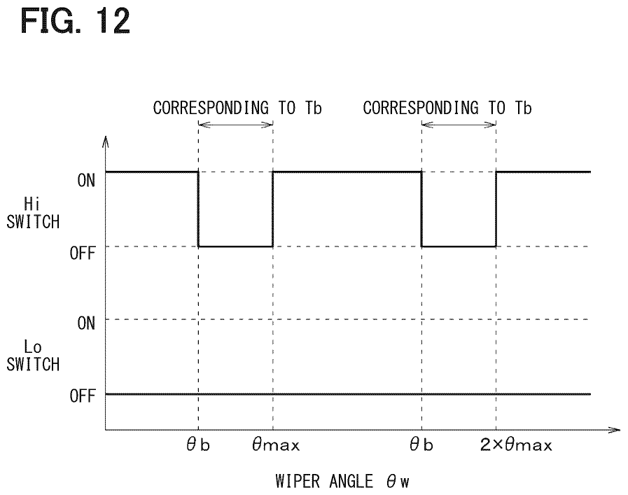

In contrast, in the second embodiment, in step S108, when the operating state of the wiper 90 is the continuous high-speed mode and the wiper angle θw is the deceleration start angle θb, the drive unit 62 does not turn on the Lo switch 45, but keeps it off, as shown in FIG. 12.

In this manner, in the second embodiment, deceleration control is performed by the drive unit 62. The second embodiment achieves effects similar to the effects achieved by the first embodiment.

### Other Embodiments

The present disclosure is not limited to the embodiment, and the embodiment can be appropriately modified. Individual elements or features of a particular embodiment are not necessarily essential unless it is specifically stated that the elements or the features are essential in the foregoing description, or unless the elements or the features are obviously essential in principle.

The drive unit, the acquisition unit, the estimation unit, the calculation unit, and the methods thereof described in the present disclosure may be realized by a dedicated computer provided by configuring a processor, programmed to execute one or more functions embodied by a computer program, and a memory. Alternatively, the drive unit, the acquisition unit, the estimation unit, the calculation unit and methods described herein may be implemented in a special purpose computer provided by configuring a processor with one or more dedicated hardware logic circuits. Alternatively, the drive unit, the acquisition unit, the estimation unit, the calculation unit, and the methods thereof described in the present disclosure may be realized by one or more dedicated computers configured by a combination of a processor programmed to execute one or more functions, a memory, and a processor configured by one or more hardware logic circuits. The computer programs may be stored, as instructions to be executed by a computer, in a tangible non-transitory computer-readable medium.

In each of the embodiments, the Hi switch 35, the Hi current detector 39, the Lo switch 45, and the Lo current detector 49 are separate entities. However, the Hi switch 35 and the Hi current detector 39 may be integrated. Furthermore, the Lo switch 45 and the Lo current detector 49 may be integrated. Moreover, the Hi switch 35, the Hi current detector 39, the Lo switch 45 and the Lo current detector 49 may be integrated.

In each of the embodiments, the wiper motor 100 may be either a DC motor or an AC motor. Furthermore, when the wiper motor 100 is a DC motor, it is preferable that it is a DC commutator motor of a permanent magnet field type. In this case, the wiper motor 100 is a multi-speed motor, for example, as described in JP 10-503640 A (U.S. Pat. Nos. 5,485,049 and 5,594,290 which are incorporated by reference). This multi-speed motor can change the rotation speed of the motor between low speed and high speed by selectively switching between low-speed brush and high-speed brush to change the current supply circuit to the armature. Specifically, at least a pair of permanent magnets are fixed to an inner surface of a motor yoke (not shown), and a winding is attached to the core of the armature, for example by lap winding. The Hi terminal 104, the Lo terminal 106, and the GND terminal 108 serving as brushes are arranged on the commutator so as to slide in contact with the commutator. Moreover, the Hi terminal 104 is disposed at a position that is more advanced than the Lo terminal 106. As a result, when the Hi terminal 104 is selected and power is supplied, the motor can rotate at a higher speed than when the Lo terminal 106 is selected.

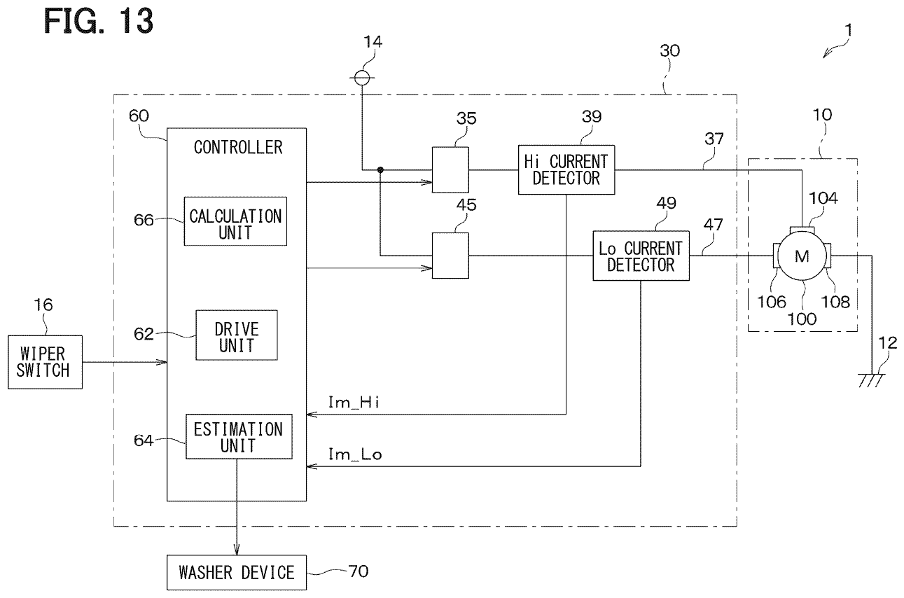

In each of the embodiments, the estimation unit 64 may output a signal corresponding to the wiper angle θw estimated in step S210 to an external device. For example, the external device is a washer device 70 as shown in FIG. 13. The washer device 70 controls a timing of ejecting washer fluid for cleaning a windshield (not shown) based on the signal from the estimation unit 64. For example, the washer device 70 ejects the washer fluid when the wiper angle θw estimated by the estimation unit 64 is zero or 2×θ max, that is, when the wiper position Pw is at the lower return position Pd. For example, the washer device 70 sprays the washer fluid when the wiper angle θw estimated by the estimation unit 64 is θ max, that is, when the wiper position Pw is the upper return position Pu.

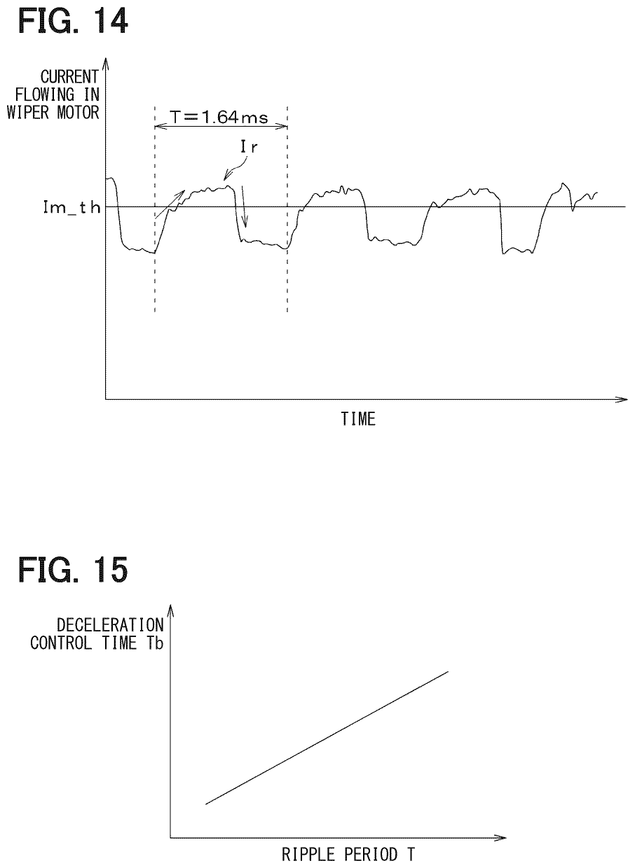

In each of the embodiments, the estimation unit 64 calculates, as the pulse number N, the number of times when the change amount Δlm is equal to or greater than the change threshold value Δlm_th. However, the number of pulses N is not limited to the number of times when the change amount Δlm is equal to or greater than the change threshold value Δlm_th. For example, as shown in FIG. 14, the estimation unit 64 may calculate, as the pulse number N, the number of times that the current flowing through the wiper motor 100 changes from a value less than the current threshold Im_th to a value equal to or greater than the current threshold Im_th. The estimation unit 64 may also calculate, as the pulse number N, the number of times that the current flowing through the wiper motor 100 changes from a value greater than the current threshold Im_th to a value equal to or less than the current threshold Im_th. The current threshold value Im_th is calculated based on the voltage applied to the wiper motor 100, for example, in the same manner as the change threshold value Δlm_th.

In each of the embodiments, the map for calculating the deceleration control time Tb is set so that the deceleration control time Tb becomes longer as the ripple period T becomes shorter. The map for calculating the deceleration control time Tb may be set so that the deceleration control time Tb becomes shorter as the ripple period T becomes shorter, as shown in FIG. 15.

What is claimed is:

1. A wiper control device comprising:
a wiper element to rotate a wiper motor by being turned on, to drive a wiper that reciprocates between a first position and a second position;
a drive unit configured to control on/off of the wiper element;
an acquisition unit configured to acquire a value related to a current flowing through the wiper motor;
an estimation unit configured to estimate a wiper angle that is a rotation angle of the wiper based on a current ripple of the current having a periodicity corresponding to drive of the wiper motor; and
a calculation unit configured to calculate a deceleration start angle based on a ripple period that is a period of the current ripple, the deceleration start angle being the wiper angle at which deceleration of the wiper is started before a position of the wiper reaches the first position and the second position, wherein
the drive unit is configured to
decelerate the wiper by switching the wiper element from on to off to stop power supply from the wiper element to the wiper motor when the wiper angle reaches the deceleration start angle, and
resume the power supply from the wiper element to the wiper motor by switching the wiper element from off to on when a position of the wiper is one of the first position, a position earlier than the first position, the second position, and a position earlier than the second position after the wiper angle reaches the deceleration start angle.

2. The wiper control device according to claim 1, wherein
the calculation unit calculates a deceleration control time based on the ripple period, the deceleration control time being a time from when the wiper angle reaches the deceleration start angle to when the wiper element is switched from off to on, and
the drive unit resumes the power supply to the wiper motor by switching the wiper element from off to on after the deceleration control time has elapsed since the wiper angle reached the deceleration start angle.

3. The wiper control device according to claim 1, wherein
the wiper motor includes a first terminal to which power is supplied and a second terminal to which power smaller than that supplied to the first terminal is supplied,
the wiper element is a first element,
the first element is turned on to rotate the wiper motor by the current flowing through the wiper motor via the first terminal,
the wiper control device further comprising: a second element that is turned on to rotate the wiper motor by the current flowing through the wiper motor via the second terminal,
the drive unit is configured to control on/off of the first element and the second element,
when the wiper angle becomes the deceleration start angle, in case where the first element is on and the second element is off, the drive unit is configured to
stop power supply from the first element to the wiper motor by switching the first element from on to off, and
decelerate the wiper by switching the second element from off to on to supply power from the second element to the wiper motor, and
when the position of the wiper is one of the first position, a position earlier than the first position, the second position, and a position earlier than the second position after the wiper angle has reached the deceleration start angle, the drive unit is configured to
resume the power supply from the first element to the wiper motor by switching the first element from off to on, and
stop the power supply from the second element to the wiper motor by switching the second element from on to off.

4. The wiper control device according to claim 1, wherein
the wiper motor includes a first terminal to which power is supplied and a second terminal to which power smaller than that supplied to the first terminal is supplied,
the wiper element is a first element,
the first element is turned on to rotate the wiper motor by the current flowing through the wiper motor via the first terminal,
the wiper control device further comprising: a second element that is turned on to rotate the wiper motor by the current flowing through the wiper motor via the second terminal,
the drive unit is configured to control on/off of the first element and the second element,
when the wiper angle becomes the deceleration start angle, in case where the first element is on and the second element is off, the drive unit is configured to
decelerate the wiper by switching the first element from on to off to stop the power supply from the first element to the wiper motor and keep the second element off, and
resume the power supply from the first element to the wiper motor by switching the first element from off to on to while the second element is kept off when the position of the wiper is one of the first position, a position earlier than the first position, the second position, and a position earlier than the second position, after the wiper angle reaches the deceleration start angle.

5. The wiper control device according to claim 3, wherein
when the wiper angle becomes the deceleration start angle in case where the second element is on and the first element is off, the drive unit is configured to
decelerate the wiper by switching the second element from on to off to stop the power supply from the second element to the wiper motor and keep the first element off, and
resume the power supply from the second element to the wiper motor by switching the second element from off to on, while the first element is kept off, when the position of the wiper is one of the first position, a position earlier than the first position, the second position, and a position earlier than the second position after the wiper angle reaches the deceleration start angle.

6. The wiper control device according to claim 1, wherein
the wiper motor includes a first terminal to which power is supplied; and a second terminal to which power smaller than that supplied to the first terminal is supplied,
the wiper element is a first element,
the first element is turned on to rotate the wiper motor by the current flowing through the wiper motor via the second terminal,
the wiper control device further includes a second element that is turned on to rotate the wiper motor by the current flowing through the wiper motor via the first terminal,
the drive unit is configured to control on/off of the first element and the second element, and
when the wiper angle becomes the deceleration start angle in case where the first element is on and the second element is off, the drive unit is configured to
decelerate the wiper by switching the first element from on to off, while keeping the second element off, to stop the power supply from the first element to the wiper motor, and
resume the power supply from the first element to the wiper motor, while the second element is kept off, by switching the first element from off to on, when the position of the wiper is one of the first position, a position earlier than the first position, the second position, and a position earlier than the second position after the wiper angle reaches the deceleration start angle.

7. The wiper control device according to claim 1, wherein the estimation unit estimates the wiper angle based on the number of times that an absolute value of a change in current flowing through the wiper motor is equal to or greater than a threshold.

8. The wiper control device according to claim 1, wherein the estimation unit estimates the wiper angle based on the number of times that the current flowing through the wiper motor changes from a value less than a threshold to a value equal to or greater than the threshold.

9. The wiper control device according to claim 1, wherein the estimation unit estimates the wiper angle based on the number of times that the current flowing through the wiper motor changes from a value greater than a threshold to a value equal to or less than the threshold.

10. The wiper control device according to claim 7, wherein the calculation unit calculates the ripple period based on the number of times.
